(19) United States
(12) Patent Application Publication
(10) Pub. No.: US 2008/0238136 A1
(43) Pub. Date: Oct. 2, 2008

(54) Motor Vehicle Door

(75) Inventor: Michael Fuetterer, Hildrizhausen (DE)

Correspondence Address: CROWELL & MORING LLP;INTELLECTUAL PROPERTY GROUP, P.O. BOX 14300, WASHINGTON, DC, 20044-4300, US

(73) Assignee: Daimlerchrysler AG, Stuttgart (DE)

(21) Appl. No.: 11/632,115

(22) PCT Filed: Jun. 18, 2005
(86) PCT No.: PCT/EP05/06608

§ 371 Date: Jan. 9, 2008

(30) Foreign Application Priority Data
Jul. 15, 2004 (DE) 202004015344.0
Mar. 1, 2005 (DE) 102005009183.0

(51) Int. Cl. B60J 5/04

(52) U.S. Cl. 296/146.6

(57) ABSTRACT

A motor vehicle door comprises an outer module and an inner module, with the inner module having an inside door lining which is fitted onto a supporting surface of the inner module. The inner module has a supporting structure which comprises a metallic frame which in turn is joined to a plastic base support so as to form a metal-plastic hybrid component. The hybrid component at the same time forms the supporting surface of the inside door lining.

### BACKGROUND AND SUMMARY OF THE INVENTION

This invention relates to a motor vehicle door.

Motor vehicle doors in modern passenger vehicles are frequently composed of different modules. In this connection, the motor vehicle door frequently comprises an outer module, which has a frame, an outer panel and side impact protection strips, and an inner module, which serves essentially for the fastening of add-on parts and door linings.

German document DE 101 33 420 A1 describes a motor vehicle door which is composed of two such modules. In this case, the inner module has a plastic housing onto which an inside door lining is furthermore fitted by means of a coating process. Various units and elements, such as, for example, speakers, are also fastened to this plastic housing. Furthermore, an additional hybrid component which is constructed from plastic and metal is screwed onto this plastic housing. Taking a door assembly as the starting point, this hybrid component is positioned, as viewed from the outside to the inside, approximately centrally, within a window plane. In this case, the actual plastic housing onto which the hybrid component is screwed does not take on any supporting properties.

The rigidity of this inner module and of the entire vehicle door is therefore capable of improvement. Furthermore, the outlay on installation for the assembled inner module is comparatively high. Furthermore, the construction space in the door is not optimally used by the hybrid component which is situated in the center, and this, inter alia, also has a negative effect on the width of the interior space.

Accordingly, the object of the invention is to improve the rigidity of the door in comparison to the prior art, to reduce the outlay on installation and to ensure better utilization of the existing construction space.

The object is achieved by a motor vehicle door as claimed.

The motor vehicle door comprises an outer module and an inner module, the inner module having an inside door lining which is fitted onto a supporting surface of the inner module.

An inside door lining is understood here as meaning any type of coating, for example comprising leather material, or plastic coverings, which, if appropriate, are fitted on a foam mounted in between, and further add-on parts, for example handles or storage compartments. These inside door linings serve for the decorative configuration of the interior space and are fitted onto a supporting surface of the inner module by corresponding joining processes.

The invention is distinguished in that the inner module has a supporting structure which comprises a reinforcing frame. This reinforcing frame is joined to a plastic base support so as to form a hybrid component. In this case, the hybrid component is configured in such a manner that it firstly improves the rigidity of the inner module and therefore of the entire door and at the same time forms the supporting surface of the inside door lining.

The reinforcing frame is frequently configured in the form of a metallic frame, with use being made of metals, such as steel, aluminum or magnesium, which can be produced by a conventional forming technique and by casting techniques. However, it is also expedient to produce the reinforcing frame by means of an insert in the form of a fiber-reinforced plastic.

The supporting structure of the inner module is therefore configured by means of an integrated hybrid component. The absence of a supporting hybrid component in the center of the door therefore significantly improves the utilization of the construction space in the vehicle door, increases the rigidity and facilitates the installation of add-on parts, since add-on parts can be greatly integrated onto the hybrid component per se.

The supporting structure of the inner module can be configured in such a manner that it additionally comprises a window breast and/or a door base and also a rear door end side. The integration of these narrow sides of the motor vehicle door into the inner module makes it possible for the outer module to be of correspondingly narrower design, which in turn leads to the separating plane between inner and outer module being able to be shifted further in the direction of the outside of the vehicle, which in turn leads to an increase in the elbow room in the passenger compartment.

In this case, the rear door end side on the inner module can be configured in such a manner that a door lock is arranged on it. The arrangement of the door lock on the separately preassemblable, inner module furthermore improves the overall outlay on installation during the installation of the motor vehicle door.

In an embodiment of the invention, a door seal runs along a joining surface in which the outer and the inner module are joined together. This serves firstly also to better seal the joining surface and furthermore can also serve to cover screw points, which run along the joining surface, by the door seal at the same time, which affords optical advantages.

The supporting structure of the inner module, which is configured in the form of the abovementioned hybrid component, can be geometrically shaped in such a manner that installation spaces for corresponding add-on parts are formed in the desired manner on the inner module, for example for units.

In this case, in an advantageous manner, the plastic base support, which forms part of the hybrid component, can have fastening means which are already integrated into the plastic base support by means of the production process. These fastening means likewise serve to fasten add-on parts in units.

In an embodiment of the invention, a drive unit of a window lifter can be fitted in the outer module of the motor vehicle door. This likewise leads to a better utilization of the existing construction space.

In this connection, it is expedient for the drive unit for the window lifter to be fitted between a window plane and an outside door panel. This region of the motor vehicle door otherwise remains unused.

It is furthermore expedient to arrange a front door end side on the outer module, which door end side is offset in a stepped manner in its cross section. Said region of the door end side which is offset in a stepped manner, together with a front end region of the inner module, can delimit a hollow cross section. By this means, the rigidity of the motor vehicle door is further increased, in particular in the highly loaded front door region. This increase also occurs in particular when the hybrid component of the inner module is configured in the form of a metal or the metallic frame in the region of the delimitation of the hollow cross section and the hollow cross section is therefore delimited in an encircling manner by means of a metal.

Further advantageous embodiments of the invention are explained in more detail with reference to the following figures.

### BRIEF DESCRIPTION OF THE DRAWINGS

FIG. 1 shows a view of the outer motor vehicle door module, as seen from the inside to the outside,

FIG. 2 shows a view of the inner module with a view from the outside to the inside,

FIG. 3 shows the supporting structure of the hybrid component of the inner module with a graphical differentiation between reinforcing frame and plastic base support,

FIG. 4 shows a schematic illustration of a vehicle door, in which the position of the sections according to FIGS. 5 to 7 is shown,

FIG. 5 shows a section along the line V of FIG. 4,

FIG. 6 shows a section along the line VI of FIG. 4,

FIG. 7 shows a section along the line VII of FIG. 4,

FIG. 8 shows a section along the line VI of FIG. 4,

FIG. 9 shows a section along the line IX of FIG. 4,

FIG. 10 shows a section along the line X of FIG. 4,

FIG. 11 shows a schematic cross section in the region of a window lifter unit, and

FIG. 12 shows a schematic illustration of the outer module with side impact protection means and reinforcement of the window base edge.

### DETAILED DESCRIPTION OF THE INVENTION

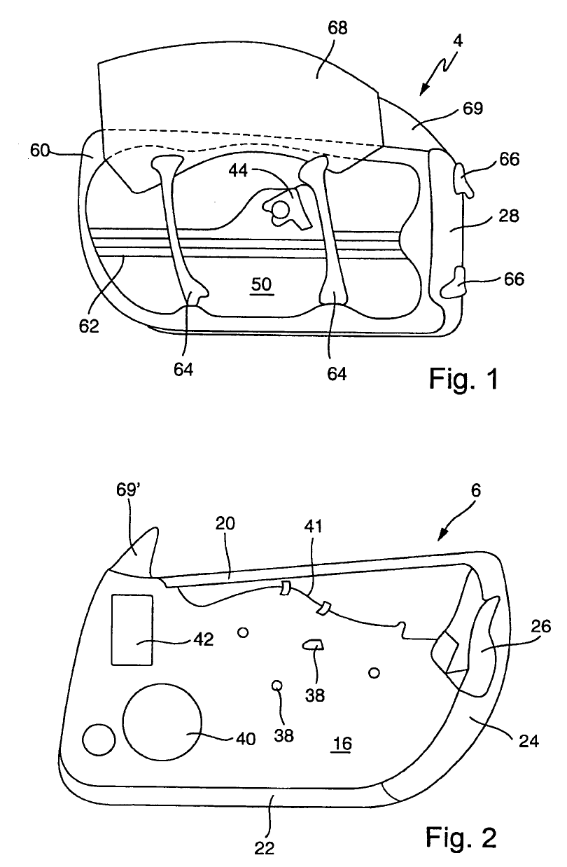

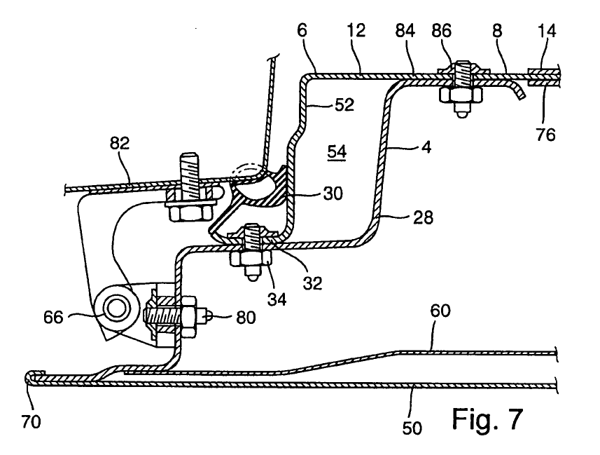

An illustration of an outer module 4 of a motor vehicle door 2 (cf. FIG. 4) is provided in FIG. 1. The outer module 4 in this case comprises a frame 60 to which an outside panel 50 is attached; furthermore, a side impact protection means 62 runs from a front to a rear end of the module and ends in a front door end side 28. The front door end side 28 at the same time conceals hinges 66. The construction of the front door end side 28 is explained in more detail in the description of FIG. 7.

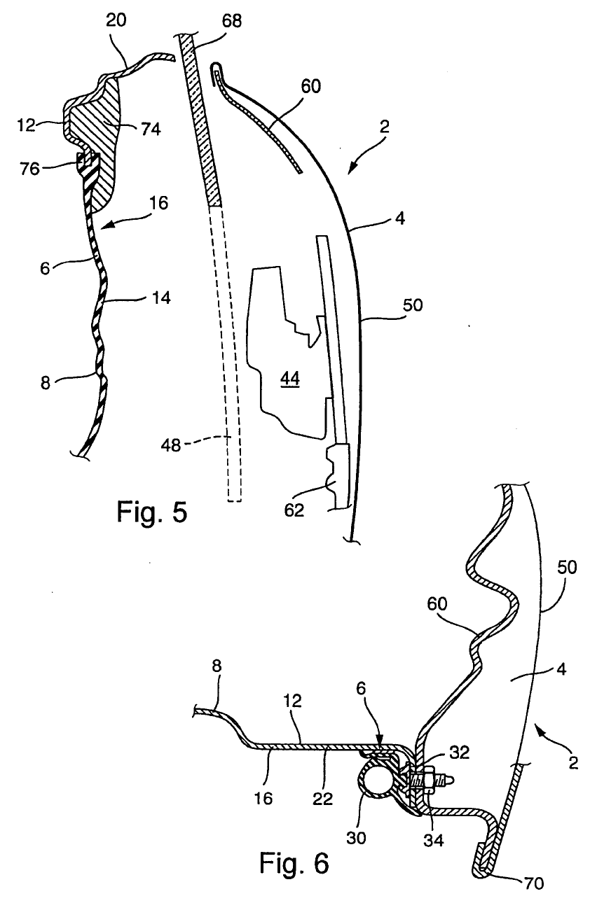

Furthermore, the outer module comprises a window 68 and rails 64 of a window lifter and a drive unit 44 of a window lifter, which is mounted on a bulging portion of the side impact protection means 62. As can be seen in FIG. 5, the drive unit 44 of the window lifter lies outside a window plane 48 (FIG. 5), which is of advantage for the construction space in an inner module 6.

In principle, the outer module can also comprise regions of the door base, the window breast and the front and rear door end sides. However, there are endeavors to largely integrate these narrow sides of the door in an inner module 6.

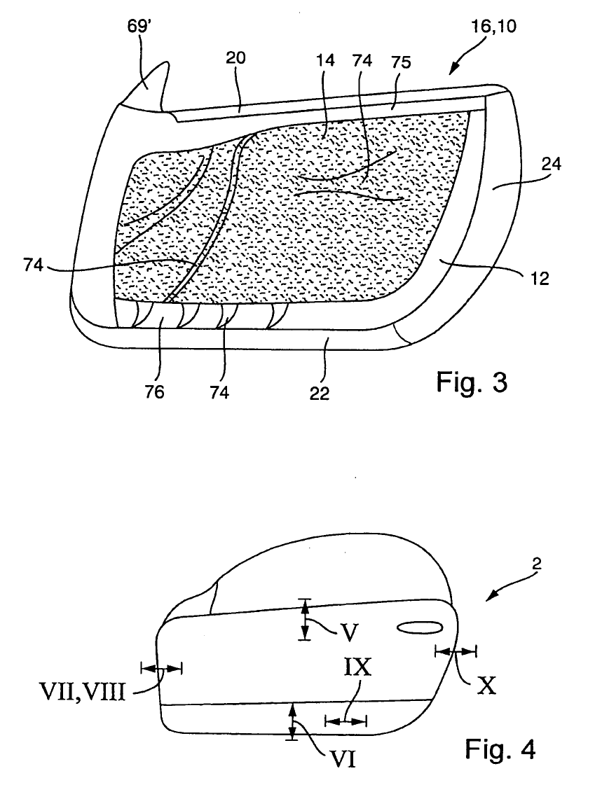

The inner module 6 of the motor vehicle door 2 is illustrated in FIG. 2. The view of the inner module 6 in this illustration runs from the outside to the inside. The inner module 6 is based essentially on a supporting structure 10 which in turn is formed by a hybrid component 16, which is viewed separately and in detail in FIG. 3.

In addition to the hybrid component 16, the inner module 6 comprises various add-on parts 40, for example speakers or installation units 42, such as a door control device. Furthermore, fastening means 38 to which further add-on parts, for example door handles, can be fastened are integrated in a plastic base support 14 (cf. FIG. 3). Furthermore, the inner module 6 comprises supply lines 41, such as, for example, electric cables or Bowden cables, for actuating locks. A door lock 26 is likewise integrated in the inner module in the region of a rear door end side 24.

Furthermore, in this embodiment, the inner module comprises a window breast 20 which protrudes outward from the passenger compartment in the direction of the window 68, and a door base 22 which delimits the lower side of the door. The integration of these narrow sides, namely the window breast 20, the door base 22 and the rear door end side 24, leads to the inner module 6 being of significantly thicker configuration in comparison to the outer module 4. This in turn affords the possibility of providing installation spaces for the add-on parts 40 and units 42 already discussed in the inner module. Furthermore, in this embodiment, the outer module 4 and the inner module 6 comprise a respective triangular mirror 69 and 69′.

FIG. 3 illustrates the supporting structure 10, which is formed by the hybrid component 16, in more detail. The hybrid component 16 essentially comprises a reinforcing frame 12, which is illustrated in white in FIG. 3 and is configured in the form of a metallic frame 12. The latter is referred to below as the metallic frame. Furthermore, the hybrid component comprises a plastic base support 14, which is realized in dotted form in the illustration according to FIG. 3. In this embodiment, the frame 12 is composed of a plurality of inserted sheet-metal structures which in this case comprise the door breast 20, the rear end side 24 and the door base 22. Next to these narrow sides, the metallic frame 12 is drawn into a side surface of the hybrid component 16, which contributes to further stiffening the hybrid component 16. The center of the side surface 75 is formed by the plastic base support 14.

In order to produce the hybrid component 16, first of all frame elements which form the reinforcing frame, in particular the metallic frame 12, are placed into a suitable injection mold, with free regions, which later form the plastic base body 14, being injected with a plastic compound. In this case, the frame elements are encapsulated by the plastic compound by injection molding and/or are injected through in regions of cutouts in the frame elements by the plastic compound, thus resulting in a fixed and stiff connection of the frame elements. If required, before being placed into the mold, the frame elements may also be joined to one another by welding or by a different joining method.

In this case, it is expedient to integrate plastic ribs 74 into the plastic base support 14 in order to additionally stiffen the hybrid component 16. During this injection molding process, the fastening means 38 which have already been described (cf. FIG. 2) can also be integrated at the same time. As a rule, regions 76 of the frame are also covered by the plastic base support, which firstly is necessary in order to improve the connection between plastic base support 14 and metallic frame 12 and secondly can serve as a means of coating the frame. This measure also enables fastening means 38 in the region of the frame 12 or above the metallic frame 12 to be configured from plastic. In addition to sheet-metal parts, the metallic frame 12 may also comprise cast parts, for example of aluminum, magnesium or else thin-walled cast steel. Furthermore, the use of fiber-reinforced plastics as frame elements is expedient. Frame elements of this type may be reinforced, for example, by glass fibers, aramide fibers or carbon fibers in the form of long fibers.

The metallic frame 12 is illustrated merely by way of example in its embodiment in FIG. 3. A plurality of different embodiments of the metallic frame is conceivable here, for example sheet metal can run diagonally through the hybrid component 16. It is also not a prerequisite in all cases for the metallic frame 12 to surround the hybrid component 16 from the outside and along the narrow sides. However, the configuration of the narrow sides by means of the metallic frame provides an expedient and advantageous stiffening of the hybrid component 16.

On a passenger compartment side (not visible in FIG. 3), the entire hybrid component 16 has a supporting surface 8 (cf. FIG. 5) which can be provided for decorative reasons in the interior with a coating, for example by means of leather, materials or plastic linings. This supporting surface 8 of the hybrid component 16 is generally essentially formed by the plastic base support 14. This means in general that, on a passenger compartment side of the hybrid component 16, the frame 12 is amply covered by the plastic base support 14.

In FIG. 5, which illustrates a section along the line 5 from FIG. 4 in the region of the door breast, the outer module 4 is depicted on the right side and the inner module 6 is depicted on the left side. A window 68 and a window plane 48 (illustrated by dashed lines) run between the two modules. It can be seen here that, contrary to a conventional construction of motor vehicle doors, an inside door panel, which is generally arranged between the window plane 48 and a support part for inside add-on parts, is omitted. In this construction, the reinforcing action of the customary inside door panel is formed by the hybrid component with its metallic frame 12 and the plastic base support 14.

The absence of this inside door panel means that the window plane is open on the outer module 4, as also illustrated in FIG. 1. The installation and setting of the window and of the window lifter components is thereby significantly facilitated.

By means of the substantial integration of the window breast 20 and of the door base 22, which is not depicted in FIG. 5, and of the rear door end side 24 into the inner module 6 (which features are fitted to the outer module in the customary construction) and by means of the simultaneous saving of the inside door panel, the inner module 6 can be brought significantly closer to the window plane 48 and can be of correspondingly thinner configuration, which is of direct advantage for the elbow room in the passenger compartment. The absence of a hybrid component in the center of the motor vehicle door in front of the window plane, as is described in the prior art, also leads to the inner module 6 being able to be of correspondingly thinner configuration and to the elbow room being able to be increased.

In addition to the frame 60 of the outer module and the outside panel 50, the outer module 4 in FIG. 5 has a side impact protection means 62 to which the drive unit 44 for the window lifter is fastened. In particular in the case of vehicles with convex doors, this construction space can be used for accommodating the drive unit 44.

In the section through the inner module 6 in FIG. 5, in addition to the metallic frame 12, which firstly comprises the window breast 20, the plastic base support 14 is also illustrated. The plastic base support 14 overlaps the metallic frame 12 in an overlapping region 76. In this illustration, the overlapping region 76 is configured to be very short; it may, as already indicated, also comprise the entire region of the metallic frame 12 on the interior side and therefore form the supporting surface 8 for the inside door lining. Furthermore, this sectional illustration schematically depicts a ribbed structure 74 which is integrated into the plastic base support 14 but runs beyond the latter into the frame 12 and therefore reinforces the frame 12 here in the region of the window breast 20.

The section illustrated in FIG. 6 through the vehicle door 2 along the line 6 from FIG. 4 shows the cross section of the motor vehicle door 2 in the region of the door base. On the right side, the illustration shows the outer module 4, which comprises the outside panel 50 and the frame of the outer module 60, the outside panel 50 being connected to the frame 60 in a fold 61 at the lower edge of the figure. Furthermore, the inner module 6 in the region of the door base 22 is depicted on the left side of FIG. 6. In this region, the door base 22 is mainly formed by the metallic frame 12 of the hybrid component 16.

The inner module 6 is screwed to the outer module 4 at an overlapping joining surface 32 by means of a plurality of screw points 34. The joining surface 32 with the screw points 34 is concealed by a door seal 30. This firstly has optical advantages, namely that the joining surface cannot be seen, and contributes to the sealing of the joining surface 32. Other connecting methods, such as adhesive bonding or riveting, may likewise be expedient.

FIG. 7 depicts a section along the line 7 in FIG. 4 in the region of the front door end side. The section in FIG. 7 shows hinges 66 which are screwed to the outer module 4 by means of a screw connection 80. The outer module 4 has a front door end side 28 at this point. The front door end side 28 is the single narrow side of the door that is arranged in the outer module 4 in this embodiment.

The front door end side 28 is configured such that it is stepped in its cross section; in this embodiment, is configured such that it has two steps. It is covered here by a front end region 52 of the inner module 4, this front end region 52 with the stepped arrangement of the front door end side 28 enclosing a cavity 54. The joining surface 32 (already described with regard to FIG. 6) with the screw point 34 and the seal 30 is arranged outside the hollow cross section 54. On the inside of the door, a further joining surface 84 with a further screw point 86 is likewise arranged outside the hollow cross section 54. This doubling of the inner module and the outer module, which forms the hollow cross section 54, serves in conjunction with the dual screw connections 86, 34 to form a further stiffening of the entire motor vehicle door 2. In this case, that region of the inner module 6 which delimits the hollow cross section 54 is preferably realized by the metallic frame 12 of the hybrid component 16 in order to further reinforce the stiffening effect of the hollow cross section 54.

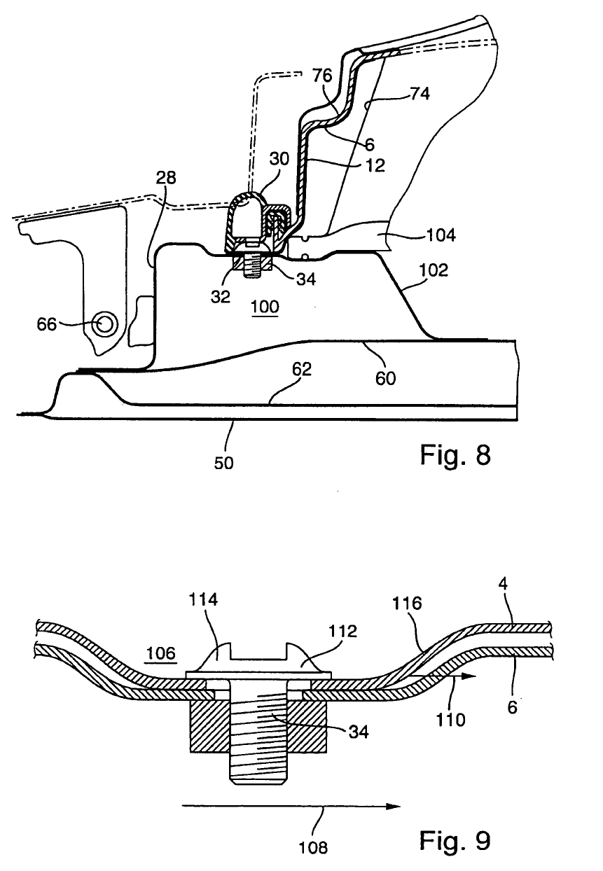

FIG. 8 illustrates a section through the line 8 in FIG. 4, which depicts the same cutout of the cross section already discussed in FIG. 7. The configuration according to FIG. 8 differs from that in FIG. 7 in that, although a further reinforcement 102 is also provided here in the region of the hinge 66, this reinforcement 102 is arranged by means of the sheet metal on the outer module 4. The reinforcement 102 in its cross section, together with the frame 60 of the outer module 4, forms the cavity 100. The hinge 66 is firstly connected to the reinforcement 102 and the joining surface 32 to the inner module 6 is secondly also situated on the reinforcement 102. The inner module 6 and the outer module 4 are connected along the joining surface 32 by screw points 34.

The reinforcement 102 for the hinges 66 is accordingly merely connected to the frame 60 of the outer module 4. In the event of changing a vehicle outside skin, for example for upkeep work on the model, only the outside panel and the frame of the outer module 4 have to be changed in this case. The reinforcement 102 and the inner module 6 can remain unchanged, as a result of which development and tool costs can be saved.

In the example according to FIG. 8, a sealing surface 104 is arranged between the inner module 6 and the outer module 4, said sealing surface firstly protecting the inner module 6 against moisture and secondly serving to reduce noise. To advantageously reduce noise, the sealing surface 104 is configured as a molded foam part onto which a film can be laminated, on its side facing the outer module 4. To protect against moisture, the molded foam part can also be configured on one side such that it has closed pores.

The reinforcing structure 102 in the region of the front door end side 28 brings about a direct connection of the outer module 4 of the motor vehicle door 2 to the vehicle body. In the event of a head-on crash, the force introduced by the crash is initially transmitted along force lines to the outer module, which leads to a screw connection 34, in particular in the seal region, as illustrated in FIG. 9, being subject to severe shearing forces.

FIG. 9 illustrates a screw connection of the outer module 4 and of the inner module 6 in the region of a vehicle seal (cf. line IX in FIG. 4). The arrow 108 here indicates the longitudinal direction of the vehicle from the front to the rear. In the case of the head-on crash already discussed, by means of an arrangement according to FIG. 7, the force is introduced into the outer module 4 and the latter therefore executes a movement with respect to the module 6 along the arrow 110. By means of a shearing movement of this type, there would be the risk of the screw 110 being sheared off. For this reason, in an advantageous configuration of the invention, a depression 106 is provided in the surroundings of the screw points 34, in which case it can be seen with reference to FIG. 9 that, in the event of a head-on crash, the outer module 4 is pressed along the shearing movement 110 onto the inner module 6 and the relative movement between the module 4 and the module 6 is stopped. In particular, the outer module 4 has sufficient distance under the screw head in the region of the screw point 34, so that the shearing movement 110 comes to a standstill only by the outer module 4 bearing against the inner module 6 in the region of an edge 116 of the depression, before a critical shearing force acts on the screw 112.

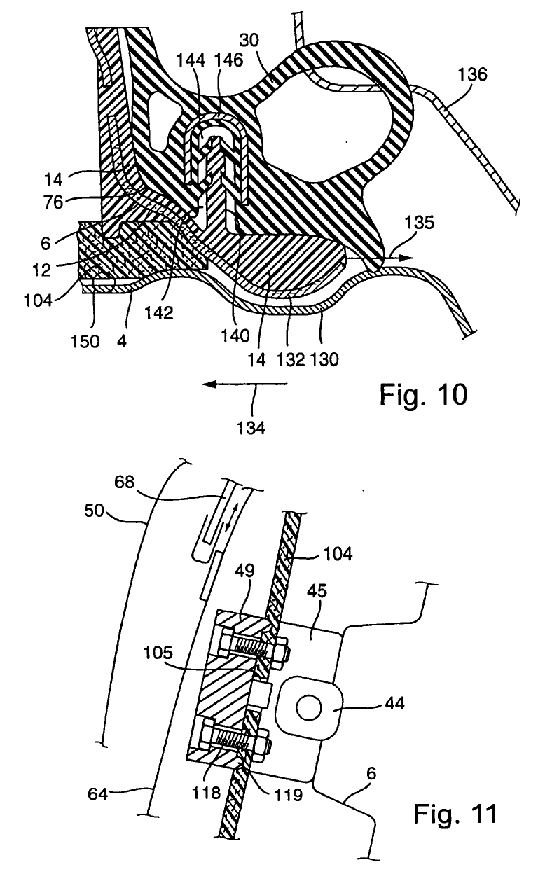

In an analogous manner to FIG. 9, which illustrates a seal region of the motor vehicle door, similar depressions are illustrated in FIG. 10 along a line of the section X in FIG. 4. In the region of the rear door end side, above and below the door lock 26, the inner module 6 and the outer module 4 respectively have beads 132 and 130 running vertically. These beads 130, 132 which run vertically are joined into each other in such a manner that, in the event of a head-on crash (energy introduction counter to the direction of travel, which is indicated by the arrow 134), said beads push against each other, become wedged and a further relative movement of the module 4 and of the module 6 is prevented. At the same time, the application of the crash energy causes the inner module 6 to move in relation to the outer module 4 along the arrow 135. By means of the beads 130 in the outer module 4 and 132 in the inner module 6, this relative movement in a manner opposed to the direction of travel is stopped, thus significantly increasing the rigidity of the door.

FIG. 10 furthermore illustrates the overlapping region 76 of the inner module 6, at which the metallic frame 12 and the plastic panel 14 of the hybrid component 16 overlap. A fastening web 140 in the plastics region is integrally formed into this overlapping region 76 and the seal 30 is placed in turn onto it. For this purpose, the seal 30 has an encircling hollow cross section 142 in which teeth 144 which improve the clamping of the seal 30 on the encircling web 140 are fitted. Furthermore, a preferably metallic core 146 is provided in the interior of the seal 30, said core increasing the contact pressure of the seal 30 against the fastening web 140 and therefore ensuring a secure seat of the seal 30. The seal 30 at the same time forms the main seal of the door and bears, as illustrated in the cutout according to FIG. 10, against a B-pillar 136 of the motor vehicle and thus seals off the motor vehicle door with respect to the body. The fastening, described in this manner, of the seal 30 to the inner module 6 is also illustrated graphically in FIG. 8, but is not specifically provided with reference numbers.

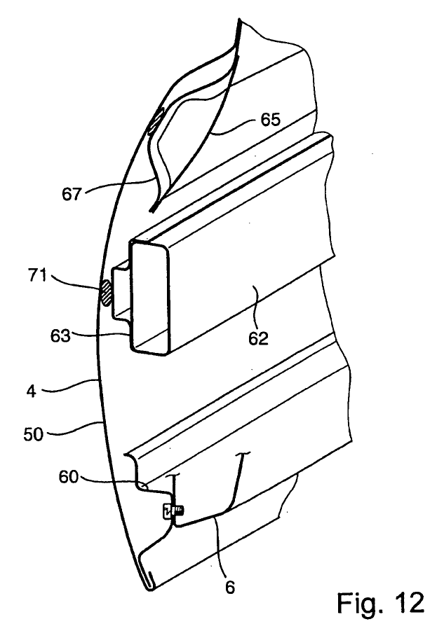

FIG. 11 provides a schematic illustration through the motor vehicle door 2 in the region of a window lifter unit. A window lifter drive unit 44 (an electric motor) is fastened to the inner module 6. The drive unit 44 of the window lifter is connected to a window lifter mechanism 45 which in turn is in direct contact with a cable drum 49 which in turn is in engagement with the window 68. The molded foam part 104 is arranged between the window lifter mechanism 45 and the cable drum 49 and, in this region, has at least one passage opening 105 through which the window lifter mechanism 45 and the cable drum 49 are connected to each other. By means of a screw connection 118 and, if appropriate, by means of press-on lugs 119, the molded foam part 104 is pressed together in such a manner that good sealing and reduction of noise arise between a wet region and a dry region. If appropriate, further passage openings 105 are also provided in the molded foam part 104, but, in principle, the number of passage openings should be kept as low as possible in order to minimize the entry of moisture and noises into the interior of the vehicle.

FIG. 12 provides a schematic, three-dimensional illustration of the outer module 4, with the fastening of the inner module 6 being indicated in the lower region of FIG. 12. The outer module 4 here has a frame 60 which is embodied flat in comparison with the inner module 6. The frame 60 furthermore comprises a frame part 63 supporting the side impact protection means 62. In the case of some motor vehicle doors, a reinforcement of the window-base edge 65 can also be provided in addition to the side impact protection means 62; in this case, the frame 60 likewise also has a frame part 67 supporting the reinforcement of the window-base edge 65. The frame parts 63 and 67 are preferably configured in the form of a sheet-metal deep drawn part. In this case, these parts are damped in relation to the outer panel 50 by a damping element 71 in order to prevent the outer panel 50 from flapping and noise from being produced.

In this embodiment, the side impact protection means 62 and the reinforcement of the window-base edge 65 can be realized in a simple manner by a customary extruded profile. This extruded profile has a rectilinear profile, as a result of which its production is significantly simplified. The adaptation of the geometry of the side impact protection means and/or of the reinforcement of the window-base edge takes place by means of the frame parts 63 and 67 (already mentioned) on which the reinforcing parts of the side impact protection means 62 and reinforcement of the window-base edge 65 are mounted.

By means of the reinforcements 62 and 65, which run rectilinearly, the frictional connection to the door hinges and to the entire body can be improved, as a result of which a significant stiffening of the door structure can take place. In one possible embodiment of the invention, the comparatively flat frame 60 of the outer module 4 makes it possible for the latter also to be formed by an aluminum sheet. The flat construction of the frame 60 favors the use of aluminum materials which are otherwise, because of their deforming properties, less suitable in many cases for the construction of vehicle doors. The use of aluminum materials for the frame 60 of the outer module 4 and, if appropriate, also for the outer panel 50 further reduces the weight of the motor vehicle door.

1-20. (canceled)

21. A motor vehicle door, comprising:
an outer module, and
an inner module,
wherein the inner module comprises an inside door lining which is fitted onto a supporting structure of the inner module,
wherein the inner module has a supporting structure which comprises a reinforcing frame joined to a plastic base support so as to form a hybrid component, and
wherein the hybrid component at the same time forms the supporting surface of the inside door lining.

22. The motor vehicle door as claimed in claim 21, wherein the supporting structure of the inner module comprises at least one of a window breast and a door base.

23. The motor vehicle door as claimed in claim 21, wherein the supporting structure of the inner module comprises a rear door end side.

24. The motor vehicle door as claimed in claim 23, further comprising a door lock arranged on the rear door end side of the inner module.

25. The motor vehicle door as claimed in claim 21, further comprising a door seal that runs along a joining surface of the outer module and the inner module.

26. The motor vehicle door as claimed in claim 25, wherein the door seal conceals a screw point of the joining surface of the outer module and of the inner module.

27. The motor vehicle door as claimed in claim 21, wherein the supporting structure of the inner module comprises installation spaces for add-on parts and units.

28. The motor vehicle door as claimed in claim 21, wherein the plastic base support of the hybrid component has fastening means for add-on parts and units.

29. The motor vehicle door as claimed in claim 21, further comprising a drive unit for a window lifter fitted to the outer module.

30. The motor vehicle door as claimed in claim 29, wherein the drive unit is fitted between a window plane and an outside door panel.

31. The motor vehicle door as claimed in claim 21, wherein the reinforcing frame is formed by a metal reinforcement.

32. The motor vehicle door as claimed in claim 21, wherein the reinforcing frame is formed by an insert of fiber-reinforced plastic.

33. The motor vehicle door as claimed in claim 21, wherein a front door end side arranged on the outer module is offset, in a stepped manner, with a region of the door end side, which is offset, in a stepped manner, together with a front end region of the inner module, delimiting a hollow cross section.

34. The motor vehicle door as claimed in claim 33, wherein delimitation of the hollow cross section is formed by metal.

35. The motor vehicle door as claimed in claim 21, further comprising a reinforcement for fastening a hinge connected to the outer module.

36. The motor vehicle door as claimed in claim 21, wherein a sealing surface in the form of a molded foam part is provided between the outer module and the inner module.

37. The motor vehicle door as claimed in claim 21, further comprising interengaging depressions provided in a region of screw points both in the outer module and in the inner module.

38. The motor vehicle door as claimed in claim 37, wherein the depressions are of cup-shaped configuration in a vertical joining region between the inner module and the outer module.

39. The motor vehicle door as claimed in claim 38, wherein said vertical joining region is in the region of a door base.

40. The motor vehicle door as claimed in claim 37, wherein the depressions are configured in the form of elongate beads in a horizontal joining region between the inner module and the outer module.

41. The motor vehicle door as claimed in claim 40, wherein said horizontal joining region is a region of a front door end side.

42. The motor vehicle door as claimed in claim 21, further comprising a frame of the outer module that has a supporting frame part on which a side impact protection means is arranged, wherein the side impact protection means being configured in the form of an extruded profile.
